(19) United States
(12) Patent Application Publication
(10) Pub. No.: US 2012/0271646 A1
(43) Pub. Date: Oct. 25, 2012

(54) NON COMPROMISING HOME OR CONGREGATE FACILITY RESIDENT PATIENT AND ON SITE CAREGIVER LOCATION SYSTEM WITH INTERMINABLE WIRELESS TRANSMISSION REPORTING

(76) Inventors: Raphael M. Feldman, Melville, NY (US); Ronald Ranieri, Smithtown, NY (US); Robert Heppenheimer, Northport, NY (US)

(21) Appl. No.: 13/090,532

(22) Filed: Apr. 20, 2011

(51) Int. Cl. G08B 1/08; G06Q 50/00

(52) U.S. Cl. 705/2; 340/539.12

(57) ABSTRACT

The novelty of the present invention relates to a dedicated system and applied methodology for monitoring a patient under care; so as to guard against and prevent any anticipated potential or kinetic problems arising from either the involvement, or cause of said home or congregate facility resident-patient under care; or from any situation unrelated to said home or congregate facility resident-patient's involvement or cause. Whereas said home or congregate facility resident-patient is classified as being in a state of dementia, or any physical or mental classification requiring an intrinsic form of interminable, non-compromised, on site caregiver administering. Whereby said present invention system sensor components, electronically and wirelessly, interrogates and reports patient status; monitors internal perimeter location and environment, along with external perimeter location and environment.

### BACKGROUND OF THE INVENTION

The present invention relates to a classification of patient monitoring care systems in general, but more specifically to primary degenerative dementia of the Alzheimer's type (PDDAT) and to dementia patients of all classifications. Said present invention through its novelty teaches that an improvement over prior art exists and should be obvious to anyone steeped in the arts of same. Prior art in nursing homes have long struggled with problems related to resident-patient wandering and elopement. This is further compounded in a home or congregate facility resident-patient environment. Behavior management and resident-patient safety are two of the most essential requirements of Federal and State licensing agencies and regulations on all long term care providers. If a resident-patient leaves a facility un-noticed by staff, said resident-patient is at high risk of imminent danger of personal harm possibly ending in loss of life. In addition to the severe ramifications on a Facility from a liability and public relations perspective, the facility is also subject to potentially crippling, regulatory sanctions and reimbursement fines. This prior art concept also extends to current home care systems of prior art in addition to a common scenario of a resident-patient wearing a passive RFID device approaches a door or elevator which then sets off a loud audible alarm for staff to respond. The alarm sound, alarm radius and sensitivity are fixed for all Residents regardless of their individual behavior or needs. The system is fixed to ring an alarm and/or lock a door only when approached with no tracking or monitoring capability, and no ability for the facility to adjust the system for a specified resident-patient and their specific needs. They are useless for any other purpose other than their limited range and function.

Prior art related to home care for resident-patients plagued with general dementia or primary degenerative dementia of the Alzheimer's type (PDDAT) are dealing with a degenerative mental health condition that follows as:

### State of Alzheimers Type Dementia

Dementia is characterized by the loss of or decline in memory and other cognitive abilities. It is caused by various diseases and conditions that result in damaged brain cells. To be classified as dementia, the following criteria must be met:

It must include decline in memory and in at least one of the following cognitive abilities:

1) Ability to generate coherent speech or understand spoken or written language;

2) Ability to recognize or identify objects, assuming intact sensory function;

3) Ability to execute motor activities, assuming intact motor abilities, sensory function and comprehension of the required task; and

4) Ability to think abstractly, make sound judgments and plan and carry outcomplex tasks.

The decline in cognitive abilities must be severe enough to interfere with daily life.

Different types of dementia have been associated with distinct symptom patterns and distinguishing microscopic brain abnormalities. Increasing evidence from long-term epidemiological observation and autopsy studies suggests that many people have brain abnormalities associated with more than one type of dementia. The symptoms of different types of dementia also overlap and can be further complicated by coexisting medical conditions Alzheimers Disease is the most common form of Dementia in the United States. Alzheimer's disease is a progressive, ultimately fatal, disorder in which certain types of nerve cells in particular areas of the brain degenerate and die for unknown reasons.

Vulnerable brain regions include the amygdala as well as the hippocampus and areas around the hippocampus, and affected cell populations include cortical pathways involved in catecholaminergic, seritonergic and cholinergic transmission. Advancing pathology is believed to underlie the classic clinical presentation of memory deficits followed by gradual erosion of judgment, reasoning ability, verbal fluency and other cognitive skills.

When Alzheimer's disrupts memory, language, thinking and reasoning, these effects are referred to as “cognitive symptoms” of the disease. The term “behavioral and psychiatric symptoms” describes a large group of additional symptoms that occur to at least some degree in many, but by no means all, individuals with Alzheimer's. (3)

In early stages of the disease, people may experience personality changes such as irritability, anxiety or depression. In later stages, other symptoms may occur, including sleep disturbances; agitation (physical or verbal outbursts, general emotional distress, restlessness, pacing, shredding paper or tissues, yelling); delusions (firmly held belief in things that are not real); or hallucinations (seeing, hearing or feeling things that are not there).

Many individuals with Alzheimer's and their families find behavioral and psychiatric symptoms to be the most challenging and distressing effects of the disease. These symptoms including wandering and seeking behaviors at all times of the day and night are often a determining factor in a family's decision to place a loved one in residential care. They also often have an enormous impact on care and quality of life for both the person affected with AD and their caregivers.

In the early stage. the area of memory lapse varies from moment to moment.

Family members frequently call this being “good one day and bad the next”. As individuals go through this stage, often they can no longer safely remain alone in a community; Issues related to activities of daily living (bathing, dressing, eating), money handling and the struggle to maintain independence become a daily concern to caregivers as memory loss and inability to complete tasks becomes more evident. At times they can recall their address, the year, or other major information about their life. However, they may not remember what day it is or may get days and nights mixed up. They may not remember what they were doing or where they are at any given moment.

Resident-patient or family will report an increase in forgetting things, and a decrease in ability to recognize and convey words.

Individuals will experience difficulty and anxiety when traveling in unfamiliar locations. There is generally a decrease in social skills, and marked inability to function independently in community activities.

The individual will more often forget names, important events and appointments. Individuals also will display poor judgment, or impulse control. Individuals will show signs of difficulty following conversations, movies or television plots. Anger, suspicion, and transient crying episodes occur. Often the person will be good at compensating for memory loss and denies the problem, but experiences increased anxiety. Care and supervision of such individuals now becomes a full time responsibility.

### Middle Moderate Stage of Dementia

Individuals at this level begin to require assistance with basic activities of daily living such as bathing and toileting.

Individuals may be experiencing uncontrolled searching or wandering behaviors. They may get up in the middle of the night and go out to go to a job they had 20 years ago or go get their kid off the bus.

Sometimes individuals may talk constantly of events and appointments that have already happened from past events that they look to as present events. In some cases individuals will begin to follow you around constantly and sometimes develop patterns of repeating sentences over and over again. Looking for their parents or family members already deceased such as their husbands, wives, or children. Hiding wet under garments to save for a later time, collecting others clothes and items, trying to get outside, putting on extra-clothes or undressing constantly, unable to rest, can be verbally abusive and sometimes physical towards themselves and family members as well. As each person afflicted with AD goes through these behaviors and stages differently, However the common thread for caregivers is the up and down nature of the disease—some days are wonderful while other days can turn into 3 to 4 days without any sleep or rest for any one.

Memory continues to deteriorate to a fragmentary knowledge of address and whereabouts. The person frequently cannot identify the spouses upon whom they depend for survival. The individual may have difficulty counting backwards from 10 in clinical testing.

Person's with Alzheimer's disease, early in this stage develop a fear of bathing. They forget how to adjust the water for the temperature and may become frightened, particularly of the shower. At times towel washing is all they will tolerate. Later in this stage, the person may begin to forget the mechanics of toileting and must be given step-by-step instructions for wiping and washing themselves. Decreased cognitive capacity eventually results in urinary and fecal incontinence. The lack of control is not caused by infection or physiological change, but simply by lack of memory about toileting.

Individuals are prone to agitation, violence, paranoia and delusions in place of withdrawal. Emotional changes in this stage are variable and can include obsessive symptoms such as repeating a simple cleaning activity. Individuals can show loss of will because they cannot carry through a thought long enough to determine an action. Language and communication become more impaired. The individual may be able to describe an unnamed object, but is unable to write intelligently or follow verbal instructions. The person with dementia is unable to discern dangerous situations thereby making it unsafe to be alone outside at any time. They are often fearful and anxious.

### Late Stages of Dementia

Individuals at this stage first lose the ability to speak and ultimately then to walk. Vocalizations may be reduced to grunts and screams. Persons at this stage are unaware of surroundings and require extensive watch and care or assistance.

Home resident-patients often will not recognize on site caregivers, family members or their own image in the mirror. The end stages are stupor and coma if the home resident-resident has not succumbed to aspiration, infection or other illness.

Comfort is provided and in some cases being at home is more relaxed for them, even if they are not conscious, they are still aware that family members are near and they are safe as they make their exit.

Therefore from the above conditions associated with dementia afflicted home resident-patients, it is a goal of said present invention to allow for and enable interminable, non-compromising and unrestricted safety and mobility of said home or congregate facility resident-patient in a home environs without any lapse or compromising of safety or care of said home or congregate facility resident-patient. This novelty of said present invention is put into practice with interminable communication coordination amongst a on site caregiver or a plurality of on site caregivers so defined as on site in all locations within said internal and said external designated perimeter mesh zones; and a designated remote guardian on site caregiver or a plurality of designated remote guardian on site caregivers; and a family computer portal with high speed internet access; and a remote administrator computer portal with high speed internet access.

It is another goal of said present invention to provide said home or congregate facility resident-patient with a non-compromising wristband in combination with said attached RF wireless tag that is in interminable communication with said RF wireless readers all effectively communicating with all said readers in all said designated safe perimeter mesh zones.

It is another goal of said present invention to provide a wristband with embedded wire trigger means to be the alert means for annunciating any attempted severing of said wristband by said patient, but not limited to said patient; and said severing attempt being carried out by any intruder or safety compromising personage or plurality of said safety compromising personage, not in the category of said on site caregiver or plurality of on site caregivers.

It is another goal of said present invention to provide an RF wireless reader or plurality of RF wireless readers that are in interminable communications with all other RF wireless readers and all other RF wireless tags, with purpose of providing said interminable and non-compromising care to said home or congregate facility resident-patients or plurality of said home or congregate facility resident-patients.

It is another goal of said present invention to have uncompromising and interminable awareness of said on site caregiver or a plurality of said on site caregiver personage location within said internal and said external designated perimeter mesh zones.

Another goal of said present invention is to provide within said internal and said external designated perimeter mesh zones an infra-red wireless transceiver that provides interminable motion interrogation of said home or congregate facility resident-patient's movement throughout said mesh zones.

Another goal of said present invention to incorporate within said wrist band tag, an accelerometer motion detector that is in interminable communications through electrical connexion to said RF wireless wrist tag transmitter that is in interminable communication with said family local computer portal and through high speed internet access in interminable communication with said remote administrative computer portal. Where said accelerometer motion detector emits and propagates effectively, a burst ping alert signal periodically and interminably; and where said alert signal's periodicity is optimized for the longest amount of emitted ping signal per unit time so adjusted to provide the maximum battery lifetime of said wrist tag operation.

It is another goal of said present invention to enable said GPS RF wireless transceiver to take control once said home or congregate facility resident-patient is out of range of said designated safe perimeter mesh zones; and annunciate said location of said home or congregate facility resident-patient or a plurality of home or congregate facility resident-patients periodically so that constant updating of said location under question will be received by said on site caregiver or plurality of said on site caregivers and said family computer portal and said remote administrator computer portal by way of high speed internet access. Where said GPS RF wireless transceiver interminably emits and propagates effectively, a burst ping alert signal periodically and interminably; and where said alert signal's periodicity is optimized for the longest amount of emitted ping signal per unit time so adjusted to provide said maximum battery lifetime of said wrist tag operation.

Further goal of said present invention is the interminable monitoring of said on site caregiver and if for any reason said on site caregiver leaves said home or congregate facility resident-patient designated perimeter mesh zones without notice; or failure to announce a report-in absence validation voucher, said internet accessed administration portal is alerted and said on site caregiver, or plurality of said on site caregiver personage is signaled if failure to summon said on site caregiver arises. In addition said GPS wireless transceiver embedded in said on site caregiver RF wireless transceiver tag means monitors and communicates said movement of said absent on site caregiver when out of range of all said designated mesh zones.

### SUMMARY OF THE INVENTION

In accord with the primary aspect and goal of said present invention; there is provided and maintained a designated mesh zone means and patient medical monitoring and communications system means capable of interminable and non-compromising home or congregate facility resident-patient care.

It is a further intention of said invention to provide a general monitoring care system means that can be applied without restriction to any type of patient care or living being care, such as animals in confined places of interest and environs; or inanimate objects in confined and private or public places of interest and environs.

It is an intention of said present invention to provide by a computer system means or a plurality of computer systems means with high speed internet access and communications means; interminable and uninterrupted home or congregate facility resident-patient monitoring or a plurality of home or congregate facility resident-patients monitoring; executed by wearable home or congregate facility resident-patient identification tag means, which through RF wireless means transmit communicate with in vicinity of said home or congregate facility resident patient on site caregivers, remote from said home or congregate facility resident patient on site caregivers, and computer system with high speed internet access and communications means administration portals.

It is another intention of said present invention to calculate and report said home or congregate facility resident-patient or a plurality of said home or congregate facility resident-patients movement and all kinetic activity within the perimeter of all designated interior and exterior approved and validated location and environment definitions.

It is another intention of said present invention to enable adequate unrestricted home or congregate facility resident-patient mobility without any harm to said home or congregate facility resident-patient or plurality of home or congregate facility resident-patients.

It is another intention of said present invention to monitor and report on site caregiver location information by RF wireless means.

It is another intention of said present invention to prevent said home or congregate facility resident-patient or a plurality of said home or congregate facility resident-patients from diverting away from all designated safe perimeter mesh zones by wearing a non-compromised wireless wristband tag means that has GPS transceiver capabilities and a transceiver means to report an instant location of said home or congregate facility resident-patient or a plurality of said home or congregate facility resident-patients.

It is another intention of said present invention to insure said home or congregate facility resident-patient or plurality of said patients from removing said RF wireless wristband tag means by said novelty of an embedded wire means in said strap band of said RF wireless wristband tag means. In order to remove said wristband and tag, any personage must sever and consequently cut and break the circuitous continuity of said embedded wire means.

It is another intention of said present invention to monitor and maintain secured, all portals of egress germane to all said internal and said external designated safe perimeter mesh zones for safe home or congregate facility resident-patient mobility within said safe designated perimeter mesh zones.

It is another intention of said present invention to, by action of its teaching and design, to assign and validate all designation of said non-compromising with interminable wireless transmission reporting home or congregate facility resident-patient and on site caregiver location system with all affinitive on site caregivers, all affinitive remote guardian on site caregivers, affinitive family high speed internet access computer home portal, and said affinitive administrative high speed internet access computer portal.

It is another intention of said present invention to teach that said custom software development means is unique and effective to orchestrate aggregate of said present contiguous system component means and aggregate personage with said family high speed internet access computer portal means and said administrative high speed internet access computer portal means, to insure non-compromised safety and care of said home or congregate facility resident-patient or ward or said plurality of patents or wards.

Further it is another intention of said present invention that by using a GPS satellite transceiver means in interminable and non-compromising communications with said home or congregate resident-patient's wearable wristband RF transceiver tag means, said home or congregate resident-patient or a plurality of said home or congregate resident-patients are monitored for their instant location, safety, and caregiving. Through the obvious means offered and executed by said present invention and it should be obvious to anyone steeped in the art, that these means are carried out in said manner.

### BRIEF DESCRIPTION OF DRAWINGS

FIG. 1 is a drawing of said encompassing overall home or congregate facility resident-patient monitoring care system embodiment of said present invention.

FIG. 2 is a drawing that represents a perspective view of said RF wireless concentrator embodiment of said present invention.

FIG. 3 is a perspective drawing of said wireless infra-red transceiver embodiment of said present invention.

FIG. 4 is a perspective drawing of said wireless RF reader embodiment connected to said magnetic proximity egress alert switch and said Wireless infra-red transceiver embodiment of said present invention.

FIG. 5 is a drawing of a wireless RF transmitter tag embodiment of said present invention.

FIG. 6 is a perspective drawing of said connected wireless infra-red transceiver and said connected wireless RF transceiver concentrator embodiment to said high speed internet access personal computer system of said present invention.

FIG. 7 is a perspective drawing of said wrist wireless RF transmitter tag with said non-compromise wrist band with said embedded wire alert trigger embodiment of said present invention.

FIG. 8 is a drawing of said wireless RF transceiver concentrator connected to home or congregate facility resident-patient monitoring care system high speed internet access computer of said present invention.

FIG. 9 illustrates by a perspective drawing, said wrist band and said wireless RF tag transmitter embodiment worn by said home or congregate facility resident-patient associated with said home or congregate facility resident-patient monitoring care system of said present invention.

FIG. 10 illustrates by a perspective drawing, said wireless RF tag transmitter component worn by said caretaker associated with said home or congregate facility resident-patient monitoring care system of said present invention.

FIG. 11 illustrates by a perspective drawing, said cell phone apparatus used by said guardian off site caregiver associated with overall home or congregate facility resident-patient care administrating of said home or congregate facility resident-patient monitoring care system of said present invention.

FIG. 12 illustrates by a perspective drawing, said coordination procedure of said on site caregiver, said on site caregiver, said home or congregate facility resident-patient, and said remote administrative portal.

### DETAILED DESCRIPTION ILLUSTRATIVE EMBODIMENTS OF THE INVENTION

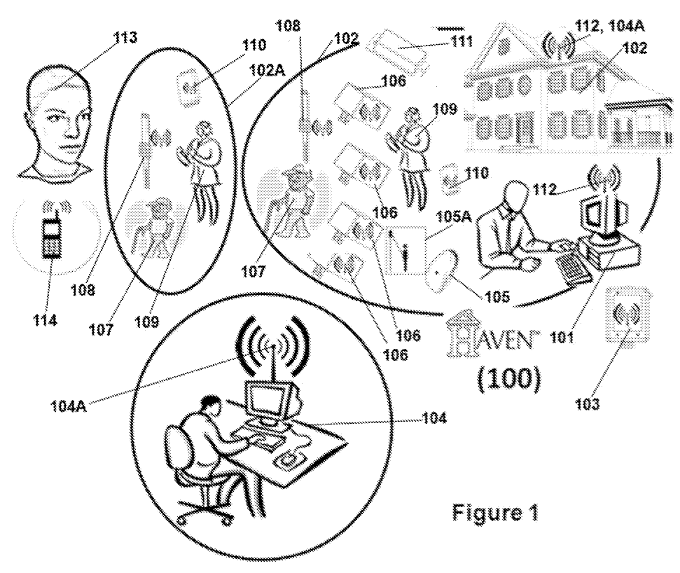

FIG. 1 shows a non-compromising home or congregate facility resident-patient and on site caregiver location system means with interminable wireless transmission reporting means according to one aspect of said present invention (100). Such a system includes a wearable RF wireless wristband tag means 108 or a plurality of wearable RF wireless transceiver wristband tag means 108, worn by said home or congregate facility resident-patient 107 or plurality of said patients 107. Said present invention teaches that wearable RF wireless transceiver wristband tag means 108 is in immediate and interminable communication with said system 100 RF wireless transceiver reader means 106 that are distributed, installed and enabled throughout said safe internal designated perimeter mesh zones 102 and that are distributed, installed and enabled throughout said safe external designated perimeter mesh zones 102A. Further in FIG. 1 it is shown that said wearable RF wireless tag means 110 is worn by said on site caregiver 109 or a plurality of said on site caregivers 109. These RF wireless tag means 110 are in immediate and interminable communication with said system 100 RF wireless readers 106 that are distributed, installed and enabled throughout said safe internal designated perimeter mesh zones 102 and that are distributed, installed and enabled throughout said safe external designated perimeter mesh zones 102A. Also said present invention teaches that said RF wireless transceiver reader means 106 is in immediate and interminable communication with RF wireless transceiver concentrator means 103 and that said RF wireless transceiver concentrator means receives patient status, GPS location and mesh zone confinement movement information from said closest RF wireless transceiver reader means 106 that relays said information from said patient 107 RF wireless wristband tags means 108 and said caretaker 109 RF wireless wearable tag means 110. FIG.1 also shows infra-red motion sensors 105 that interminably emit infra-red electromagnetic waves 105A that mesh throughout said safe internal designated perimeter mesh zones 102 and that mesh throughout said safe external designated perimeter mesh zones 102A. FIG. 1 shows another aspect of said present invention that utilizes a special remote guardian off site caregiver 113, defined as; a relative, a consulted registered practical nurse, or a neighbor all within a reasonable distance of said safe internal designated perimeter mesh zones 102 and said safe external designated perimeter mesh zones 102A. Where said special guardian on site caregiver 113, is alerted by a personal cell phone 114 that receives an alert warning call from said remote administrative high speed internet access computer portal 104. Where said remote administrative high speed internet access computer portal 104 is connected to said family high speed internet access computer portal by a complex wireless or cable high speed internet access link 104A. In FIG. 1 said safe internal designated perimeter mesh zone volumes 102 and said safe external designated perimeter mesh zone volumes 102A are all permeated with RF wireless electromagnetic energy 112 from said transmit and receive device means including said patient wearable wristband RF wireless tag means 108, said on site caregiver wearable RF wireless tag means 110, and said RF wireless reader means 106 or a plurality of said RF wireless reader means 106.

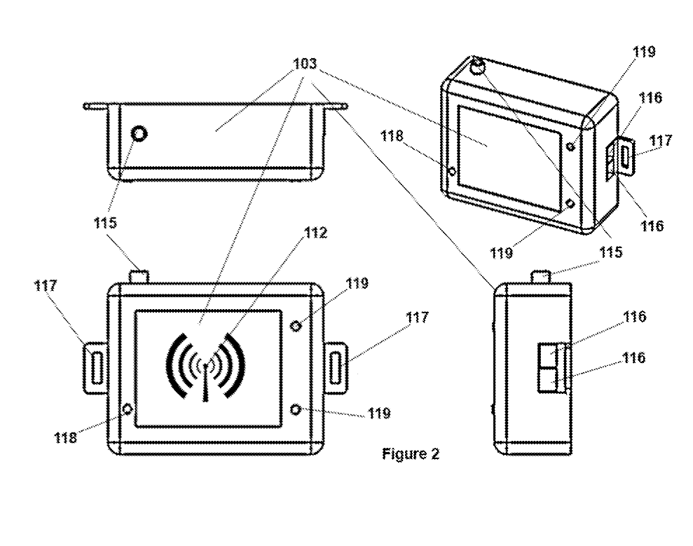

FIG. 2 is a perspective drawing of said RF wireless concentrator transceiver means 103, comprising: mounting tabs 117 that secure said concentrator 103 to any flat plane structure means. A suitable input signal connexion means 115 is available for connecting to family computer portal 101 for decoding of omni-directional reception of permeated RF energy signal waves 112. A plurality of connectors 116A and 116B provided at the base of said concentrator 103, said connectors 116A and 116B are non-functional as they are programmed in a disabled state. Said programmed disabled state remains due to the universality of said present invention component circuitry and novel interchange capability. The same base circuit board used in all readers 106 are also used in said concentrator board 103. This is another novelty of said present invention and teaches that optimum economy to said patient care system (100) will be reflected in said final system cost to consumers.

Power indicator light 118 is mounted on front side of said concentrator 103 and device indicator lights 119A and 119B are mounted on front of said concentrator 103 for visual indication of a door being opened accomplished by said indicator light 119A and any detected motion of said patient 107 by said indicator light 1198. Said door switch 111 or plurality of door switches 111 are connected to said reader 106 or a plurality of said readers 106. The reader selected for any installation of said patient care system (100) remains the selected one closest to said door switch 111 or a plurality of said door switches 111.

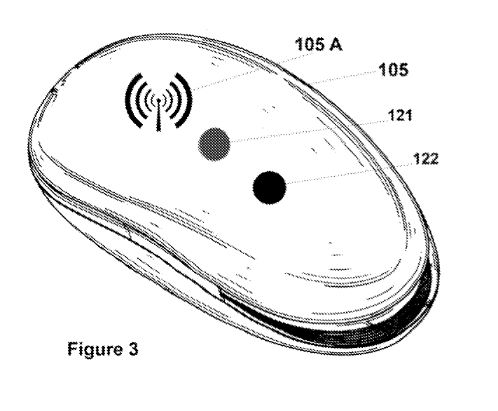

FIG. 3 shows a perspective drawing of said infra-red transceiver 105 utilized in said home or congregate facility resident-patient care system patient (100) to insure said patient safety and care by interminable infra-red monitoring of selected safety zones internal 102 and internal 102A. Where there exists an infrared transmit means 121 and an infra-red receiver or detector means 122. Said infra-red transmit means 121 interminably sends out said omni-directional infra-red electromagnetic energy and due to Doppler interference, any said received return infra-red electromagnetic energy by said infra-red receiver or detector 122, whenever there is any said patient or plurality of said patients 107 movement or motion, generated within said wireless mesh zone or plurality of zones 102 and 102A.

Another aspect and practice of said present invention is the utilization of said RF wireless transceiver readers 106.

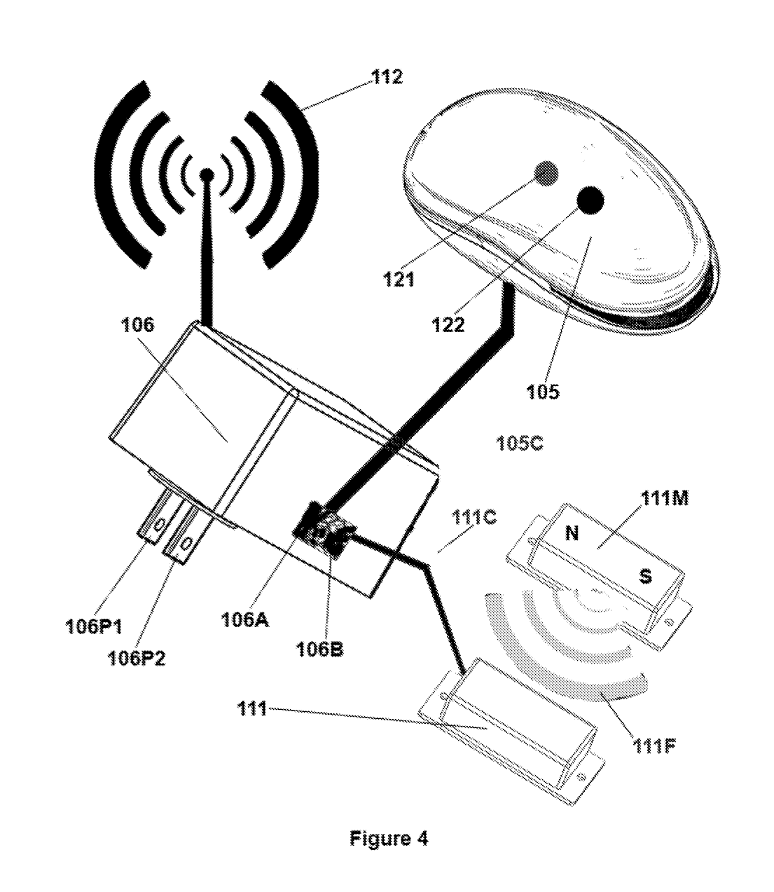

As shown in FIG. 4 said reader or plurality of readers 106 are employed to transmit and receive ZigBee Alliance encoded electromagnetic radio wave information 112, but not limited to said ZigBee Alliance encoded electromagnetic wave information 112.

FIG. 4 also illustrates a typical connexion arrangement of said infra-red transceiver 105 connected to said RF wireless transceiver reader 106 by cable 105C and further, magnetic proximity door switch 111 that is connected to said door jam in question and is triggered by the removal of said magnetic field 111F. As said door in question is moved and said permanent magnet 111M that is connected to said door is also simultaneously moved, said permanent magnetic field 111F set up by permanent magnet 111M diminishes in field strength and it is this action that triggers said magnetic proximity switch 111 to an alternative state, either from open-to-close or from close-to-open. Thus causing said reader 106 to send an encoded signal to said family portal 101 and remote administrative portal 104. The purpose of sending said encoded electromagnetic wave information 112 is to instantly alert any and all on site caregivers 109, remote guardian and other selected remote guardian off site caregivers 113 family portal administrators 101 and remote portal administrators 104 of a breach in the safety of said patient 107 or plurality of said patients 107.

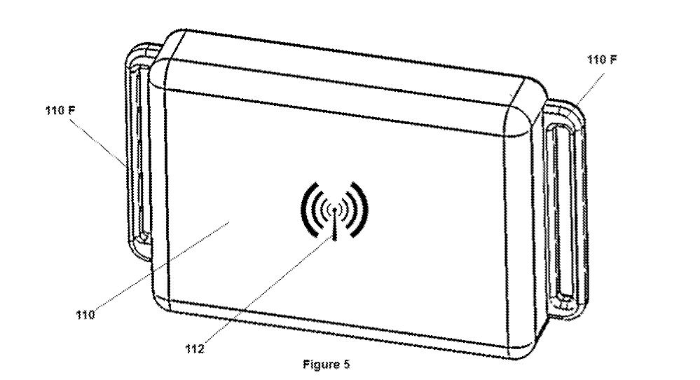

Another aspect and practice of said present invention is for said on site caregiver 109 to be 525 equipped with said wearable RF wireless transceiver tag means 110 as illustrated in FIG. 5. Said wearable RF wireless transceiver tag means 110 has said programmed capability, via its microcontroller and associated circuitry, of sending and receiving said ZigBee Alliance ISM Band 2.45 GHz. (FCC provision 802.15.4) encoded electromagnetic radio wave information 112, but not limited to said. ZigBee Alliance ISM Ban 2.45 GHz. (FCC provision 802.15.4) encoded electromagnetic wave information 112. Said wearable RF wireless transceiver tag means 110 is employed and worn by on site caregiver 109 so as to keep in compliance with said present invention operative rules and regulatory protocol procedures as part of said non-compromising with interminable wireless transmission reporting home or congregate facility resident-patient and on site caregiver location system (100). If for any reason said on site caregiver 109, fails to execute a security voucher at the beginning of a period of time designated as a watch or duty session, and further if said on site caregiver 109 removes their personage from said designated safety zones of care-giving, either internal 102 or external 102A for any reason within said period of time designated as a watch or duty session; said wearable RF wireless tag means 110 alerts family high speed internet access computer portal means 101, which instantly alerts said remote administrative high speed internet access computer system means 104 via communication link means 104A, which is said high speed internet access portal means, defined. Said on site caregiver wearable RF wireless tag means 109 is identical in operation to said patient wearable wristband RF wireless tag means 108, with the exception of said wristband means 123. A difference in programming differentiates when said tag means 110 is to be employed either by said patient 107 or said on site caregiver 109, and should be obvious to anyone steeped in the art.

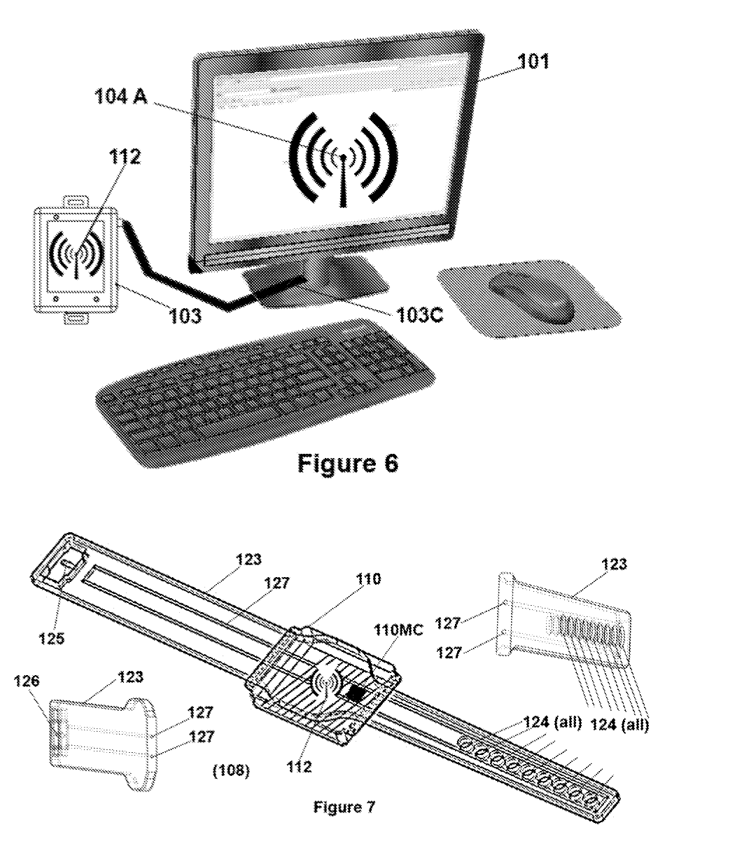

FIG. 6 is a perspective illustrative view of said family high speed Internet access computer portal 101, where said RF wireless transceiver concentrator means 103 is connected to said computer via USB (Universal Serial Bus) cable means 103C. Said RF wireless transceiver concentrator means 103 is in instant and interminable communications with said RF wireless transceiver reader means 106 or a plurality of said RF wireless transceiver reader means 106; for instant reporting and alerting gathered from said patient RF wireless transceiver tag means 108 and on site caregiver RF wireless transceiver tag means 110. Said patient RF wireless transceiver wristband tag means 108 also has a capability of a built in GPS transceiver means for instant patient location information reporting to said family portal means 101 and remote administrative portal means 104 by high speed internet access 104A.

Another aspect and practice of said present invention is show in FIG. 7, where there exists a detailed visual elaboration of said RF wireless transceiver tag means 110 that is fixed to said wristband 123 that contains said embedded thin wire loop 127. This novel methodology provides said non-compromising breach defence against said patient 107 from removing said wristband 123 RF wireless tag means 108 that is comprised of said tag means 110 and said wristband means 123.

A methodology employing said patient wristband 123 RF wireless transceiver tag means 108 utilizes a sequence of periodic transmission ping signals that follows set conditions set up in programming of said custom system software; during a defined idle state where there is no patient 107 motion detected, said patient wristband 123 RF wireless transceiver tag means 108 transmits one ping per every fifteen seconds, and is not restricted to transmitting said ping signal periodic rate of one ping per every fifteen seconds, but there can be said periodic transmission of a plurality of pings per unit time. This periodic rate is determined by calculating maximum said patient wristband 123 RF wireless tag means 108 battery lifetime under usage.

During a defined patient motion state where there is patient 107 motion detected, said patient wristband 123 RF wireless transceiver tag means 108 transmits one ping per every second, and is not restricted to transmitting said ping signal periodic rate of one ping per second, but there can be said periodic transmission of a plurality of pings per unit time. This periodic rate is determined by calculating maximum said patient wristband 123 RF wireless tag means 108 battery lifetime under usage. Said tag has a microcontroller 110MC in it. Said microcontroller 110MC wakes up periodically and tests the continuity through said embedded wire 127. Each end of said embedded wire 127 is connected to a Digital I/O pin of said microcontroller. Further said microcontroller 110 MC applies a logic level to one side of said embedded wire 127 and verifies that it appears on the other side of said embedded wire 127. The electrical configuration is such that there is no current flowing through said embedded wire 127 when the microcontroller 110 MC is asleep; this is done to conserve battery life. If said embedded wire 127 is cut for any reason by said patient 107 or any other personage or accidental situation, said microcontroller 110 MC turns tag 110 of patient wristband RF wireless transceiver 108 to transmit an alert signal throughout said mesh zones defined; internal (indoors) 102 and external (outdoors) 102A.

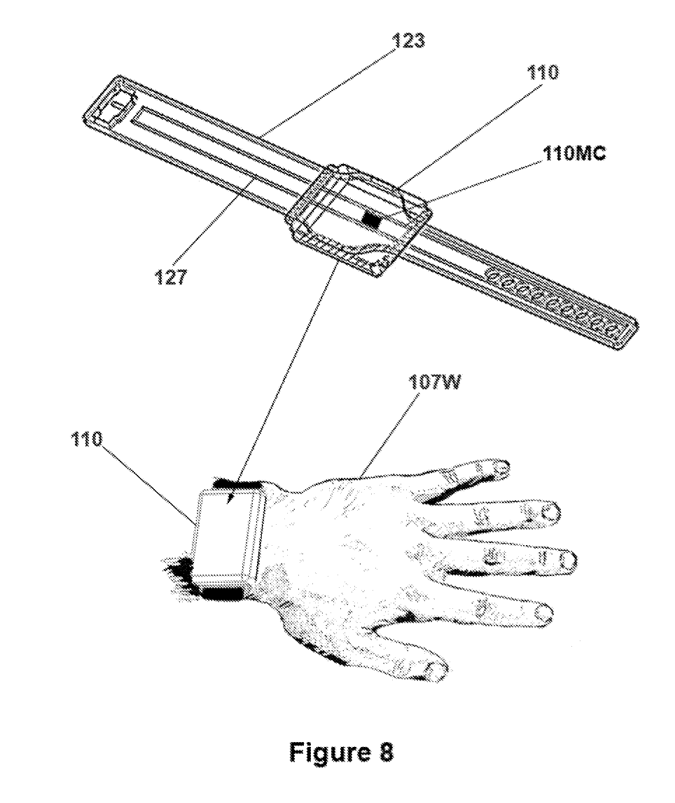

FIG. 8 illustrates said patient wristband RF transceiver tag means 108 as a combination of said RF tag 110 and wristband 123 that in combination with embedded wire 127 is employed to provide interminable non-compromising system care for said patient 107, as it is applied and fastened to said patient's wrist 107W.

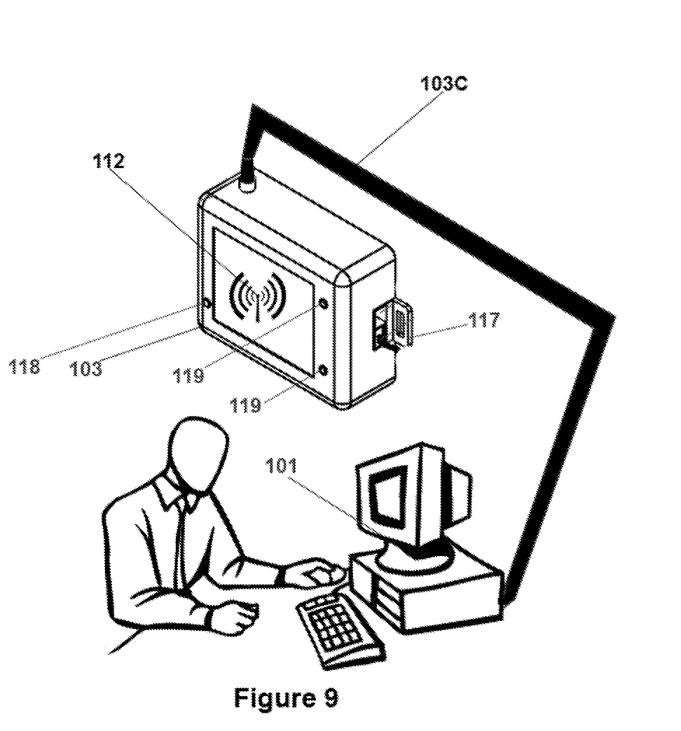

In FIG. 9 said concentrator 103 is connected to said family high speed internet access computer portal 101. Said concentrator receives said ZigBee Alliance ISM Band 2.45 GHz. (FCC provision 802.15.4) encoded electromagnetic radio wave information 112, but not limited to receiving said ZigBee Alliance ISM Band 2.45 GHz. (FCC provision 802.15.4) encoded electromagnetic wave information 112.

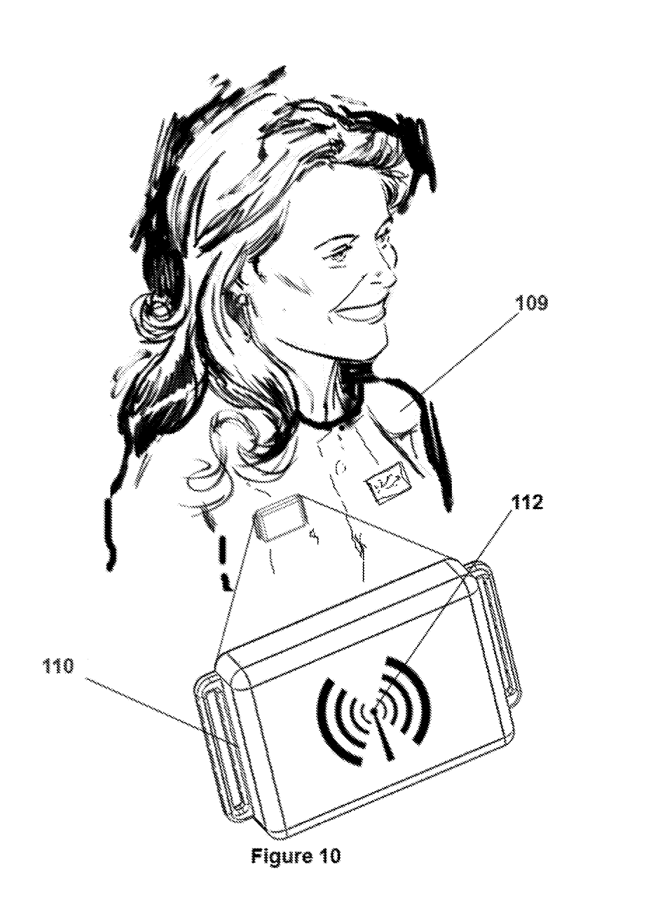

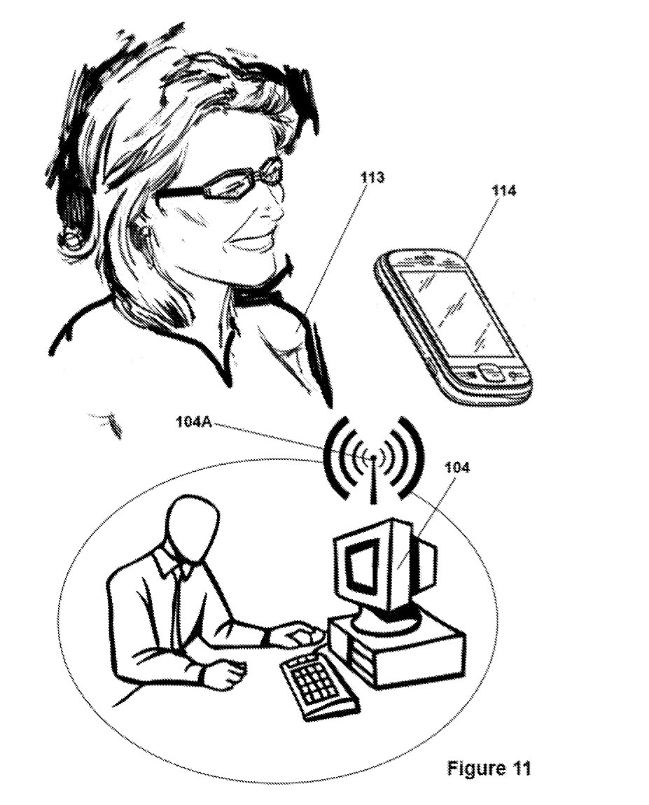

Said on site caregiver 109 as illustrated in FIG. 10 is supplied and wears said wearable RF transceiver tag 110, with capabilities of transmitting and receiving said ZigBee Alliance ISM Band 2.45 GHz. (FCC provision 802.15.4) encoded electromagnetic radio wave information 112, but not limited to receiving said ZigBee Alliance ISM Band 2.45 GHz. (FCC provision 802.15.4) encoded electromagnetic wave information 112. Upon said on site caregiver 109 exiting out of said wireless mesh zone or plurality of zones 102 and 102A for any reason without verification from reporting via a security voucher acknowledgement, RF wireless transceiver tag means 110 will transmit an alert report of said on site caregiver's absence upon exiting said wireless mesh zone or plurality of zones 102 and 102A. As illustrated in FIG. 11, if for any reason said on site caregiver 109 is absent or exits said wireless mesh zone or plurality of zones 102 and 102A, then based upon a sequence of security level conditions, said remote high speed access computer administrative portal 104 will contact said remote off site caregiver 113 via mobile phone link 114.

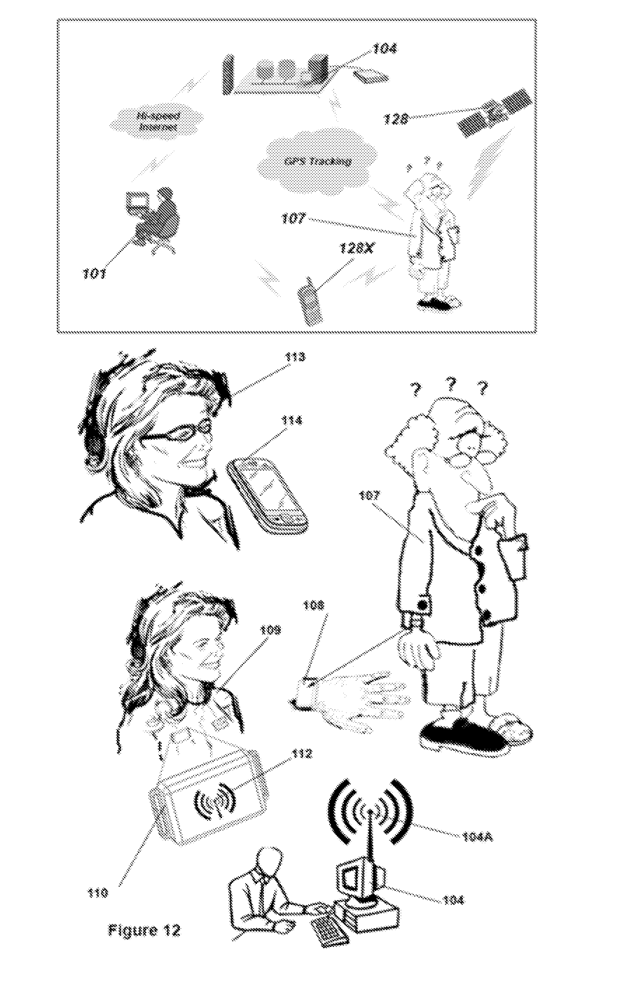

An illustrative summary in FIG. 12 of key features and embodiments of said present invention means offers that there are interminable and non-compromising care and safety offered and administered to said patient 107 or plurality of said patients 107 by said on site caregiver 109 or a plurality of on site caregivers 109. With any exit or instant absence of said on site caregiver 109, said present invention protocol will go to a level of security alert; and through said administrative portal 104, contact any and all designated remote guardian off site caregivers 113, and if required contact and alert other designated authorities. Further it is illustrated that by using a GPS satellite transceiver means 128 in interminable and non-compromising communications with said home or congregate resident-patient's wearable wristband RF transceiver tag means 108, said home or congregate resident-patient or a plurality of said home or congregate resident-patients are monitored for their instant location, safety, and caregiving.

Said present invention has been described in an illustrated manner and it is to be understood that the terminology employed is intended to be used in the nature of words of description rather than of limitation. Obviously many modifications and variations of the present invention are possible in light of the above teachings. It is, therefore, to be understood that within the scope of the appended claims wherein reference numerals are merely for convenience and are not to be in any way limiting, said present invention may be practiced otherwise than as specifically described.

1. A non-compromising home or congregate facility resident-patient location, on site caregiver monitoring and transmission system means comprising;
at least one computer system means with high speed Internet access means or a plurality of computer means, each with high speed internet access means;
at least one RF wireless transceiver concentrator interface means in communication with said computer, or a plurality of RF wireless transceiver concentrator interface means all in communication with said computer; and whereby said RF wireless concentrator interface means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
at least one RF wireless transceiver reader means, or a plurality of RF wireless transceiver reader means that are in communication with said computer through said RF wireless transceiver concentrator interface means, or plurality of RF wireless transceiver concentrator interface means and in communication with each other reader means or plurality of RF wireless transceiver reader means; and
whereby said RF wireless reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
at least one wearable non-compromising home or congregate facility resident-patient identification RF wireless transceiver tag means, or a plurality of wearable non-compromising home or congregate facility resident-patient identification RF wireless transceiver tag means that are in communication with said computer through said RF wireless transceiver reader means, or a plurality of RF wireless transceiver reader means and said RF wireless transceiver concentrator interface means, or plurality of RF wireless transceiver concentrator means; and
whereby said wearable non-compromising home or congregate facility resident-patient identification RF wireless transceiver tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
A custom software program that controls all action and interaction with said computer system with high speed internet access, or a plurality of computers, each with high speed internet access, and wireless concentrator interface means, or plurality of wireless concentrator interface means and all said RF wireless transceiver means comprising;
a wireless reader or a plurality of RF wireless transceiver readers; and
whereby said RF wireless transceiver reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
A wearable non-compromising RF wireless transceiver home or congregate facility resident-patient identification tag means or a plurality of wearable non-compromising RF wireless transceiver home or congregate facility resident-patient identification tag means; and
whereby said wearable non-compromising home or congregate facility resident-patient identification RF wireless transceiver tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility:
All of which are in communication with said home or congregate facility resident-patient and continuously monitoring all of said home or congregate facility resident-patient, or a plurality of home or congregate facility resident-patients movement in an omni-directional volume space either internal to a preferred designated perimeter environment or external to a preferred designated perimeter environment;
All of which are wirelessly in communication with a GPS for coordinates recognition and reporting.
A wearable non-compromising RF wireless transceiver on site caregiver identification tag means or a plurality of wearable non-compromising RF wireless transceiver on site caregiver identification tag means; and
whereby said wearable non-compromising RF wireless transceiver on site caregiver identification tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility;
All of which are in communication with said on site caregiver and continuously monitoring all of said on site on site caregiver, or a plurality of on site caregivers movement in an omni-directional volume space either internal to a preferred designated perimeter environment or external to a preferred designated perimeter environment;
All of which are wirelessly in communication with a GPS for coordinates recognition and reporting.

2. A interminable logical and systemic procedure methodology for a non-compromising home or congregate facility resident-patient location, on site caregiver monitoring and transmission system comprising; a custom proprietary software-firmware embodiment;
a GPS transceiver embedded in each patient wristband tag means for instant location and means of monitoring and announcing said instant location;
a GPS transceiver embedded in each caregiver RF wireless transceiver tag means for instant location and means of monitoring and announcing said instant location;

3. An attached and secured adjustable wrist or ankle band that is applied around the entire circumference of a limb such as a wrist or ankle comprising; an adjustable fastening means; and an embedded wire means that runs all throughout said adjustable band in a methodology means of surrounding the inner perimeter of said band so as to provide a closed loop in cooperation with a circuitous path for electrical current to pass; and is connected to an attached RF wireless transceiver tag means with a microcontroller embodiment means with at least one input and output port or a plurality of input and output ports for the purpose of providing; an interminable and non-compromising logic state, where said logic state is changed by action of said embedded wire is connected to a digital input/output pin of said microcontroller; and said microcontroller applies a logic level to one side of said embedded wire and verifies that it appears on the other side of said embedded wire; and said electrical configuration is such that there is no current flowing through said embedded wire when said microcontroller is asleep; and this action is established to conserve battery life.
If said embedded wire is cut for any reason by said patient or any other personage or accidental situation then;
said microcontroller turns on tag of patient wristband RF wireless transceiver to transmit;
an alert signal throughout said designated mesh zones defined; internal (indoors) and external (outdoors); and a procedure of communicating with said family portal; and
said family portal being in instant communications with said remote administration portal via high speed internet access; and said administration making a decision to alert said designated remote guardian caregiver or a plurality of said designated remote guardian caregivers.

4. The non-compromising home or congregate facility resident-patient location, on site caregiver monitoring and transmission system means as recited in claim 1, wherein said RF wireless transceiver reader means is electrically connected to said magnetic proximity door switch means; and is held in a logic state of true when any said designated door is closed and defined as safe and internal perimeter closed; and
said closed logic condition is maintained by the proximity of a permanent magnetic field means.

5. The non-compromising home or congregate facility resident-patient location, on site caregiver monitoring and transmission system means as recited in claim 1, wherein said RF wireless transceiver reader means is electrically connected to said designated infra-red wireless transceiver means; and said infra-red wireless transceiver means develops a designated infra-red mesh zone of monitoring and annunciation by action of; said Doppler effect wherein any movement from said patient will cause a change in the Doppler distribution of infra-red electromagnetic radiated energy throughout said infra-red mesh zone or a plurality of said infra-red mesh of zone; and this change in Doppler distribution triggers an annunciation and alert to said family portal and said remote administration portal.

6. The non-compromising home or congregate facility resident-patient location, on site caregiver monitoring and transmission system means as recited in claim 1, wherein there is established a interminable and non-compromising RF mesh zone network throughout said designated internal volume of patient area.

7. The non-compromising home or congregate facility resident-patient location, on site caregiver monitoring and transmission system means as recited in claim 1, wherein there is established a interminable and non-compromising RF mesh zone network throughout said designated volume that is external to said designated internal volume of patient area.

8. The non-compromising home or congregate facility resident-patient location, on site caregiver monitoring and transmission system means as recited in claim 1, wherein a methodology of utilizing a commonality and universality of circuitry for said reader or plurality of readers and said concentrator or plurality of concentrators for optimum cost effective of said recited system of claim 1.

9. The non-compromising home or congregate facility resident-patient location, on site caregiver monitoring and transmission system means as recited in claim 1, wherein a methodology of utilizing a commonality and universality of circuitry for said caregiver RF wireless tag means or plurality of said caregiver RF wireless tag means and said patient RF wireless wristband tag means or plurality of said patient RF wireless wristband tag means for optimum cost effective of said recited system of claim 1.

10. The non-compromising home or congregate facility resident-patient location, on site caregiver monitoring and transmission system means as recited in claim 1, whereby designated caregiver entry and exit voucher information; and
caregiver location information is recorded and stored in said family high speed internet access computer portal means and said remote administrative high speed internet access computer portal means.

11. The non-compromising home or congregate facility resident-patient location, on site caregiver monitoring and transmission system means as recited in claim 10, whereby designated remote caregiver or plurality of designated remote caregivers location information and mobile or home phone information is recorded and stored in said family high speed internet access computer portal means and said remote administrative high speed internet access computer portal means; and said information is alerted by said family high speed internet access portal means and remote administrative high speed internet access computer portal means.

12. The non-compromising home or congregate facility resident-patient location, on site caregiver monitoring and transmission system means as recited in claim 1, whereby it is established a commonality and universality of all system circuitry to be hardware identical;
and software changeable;
and firmware changeable;
in accord to any and all requirements to make optimum;
said present invention as recited in claim 1;
and to optimize system's requirements for any and all environs designated as a utility candidate for said present invention.

13. The non-compromising home or congregate facility resident-patient location, on site caregiver monitoring and transmission system means as recited in claim 1, whereby an action of all recorded and stored history means of all patient or all plurality of patients activity;
and further action of all caregiver or plurality of caregivers recorded and stored history means of all caregiver activity related to on site functionality;
and further action of all remote caregiver or plurality of remote caregivers recorded and stored history of all activity related to remote caregiving functionality; and
all recorded and stored information be on file with said family high speed internet access computer portal means and said remote administrative high speed internet access computer portal means.

14. The non-compromising home or congregate facility resident-patient location, on site caregiver monitoring and transmission system means as recited in claim 1, wherein a back haul methodology means is employed and utilized to evaluate, maintain, and perform any decision making for purposes of providing non-compromising home or congregate facility resident-patient safety, security, and care receiving from designated caregivers, designated remote caregivers, designated family computer portal operatives that have high speed internet access, and designated remote administrative computer portal operatives that have high speed internet access; and
whereby said back haul methodology means is executed securely and stored in said designated family portal, and designated remote administrative portal.

15. The non-compromising home or congregate facility resident-patient location, on site caregiver monitoring and transmission system means as recited in claim 1, whereby said RF wireless RF wireless transceiver sensor or transducer means;
is sensor functional and driven or transducer functional and driven; and
whereby said designated and described sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
At least one RF wireless transceiver means, or a plurality of RF wireless transceiver means that are in communication with said computer through said RF wireless transceiver concentrator interface means, or plurality of RF wireless transceiver concentrator interface means and in communication with each other RF wireless transceiver reader means or plurality of RF wireless transceiver reader means; and
whereby said RF wireless reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; or
whereby said sensor or transducer is of generic or specific type to convert electrical capacitance into digital or analogue electrical energy, for any purpose and utility; or
whereby said sensor or transducer is of generic or specific type to convert electrical inductive coupling energy into digital or analogue electrical energy, for any purpose and utility; or
whereby said sensor or transducer is of generic or specific type to convert human vital sign energy into digital or analogue electrical energy, for any purpose and utility; or
whereby said sensor or transducer is of generic or specific type to convert animal vital sign energy into digital or analogue electrical energy, for any purpose and utility; or
whereby said sensor or transducer is of generic or specific type to convert inanimate object information energy into digital or analogue electrical energy, for any purpose and utility.
